(19) United States
(12) Patent Application Publication
(10) Pub. No.: US 2024/0150958 A1
(43) Pub. Date: May 9, 2024

(54) CARBOXYLATE SALTS OF AMINE COMPOUNDS AS CURING AGENTS

(71) Applicant: Hexcel Corporation, Dublin, CA (US)

(72) Inventors: Michael Yurchenko, Madison, AL (US); Brooks Lively, Lehi, UT (US); Dale Schmidt, South Jordan, UT (US); Winston Clark Herren, Decatur, AL (US)

(21) Appl. No.: 18/334,081

(22) Filed: Jun. 13, 2023

Related U.S. Application Data
(60) Provisional application No. 63/380,657, filed on Oct. 24, 2022.

(51) Int. Cl. D06M 15/55

(52) U.S. Cl. CPC D06M 15/55; D06M 2200/40; D10B 2101/12

(57) ABSTRACT

Provided are sizing compositions, and more particularly, sizing compositions comprising an epoxy and a carboxylate salt of an amine compound for the treatment of carbon fiber. The structure of the amine used to make the carboxylate salts is RₙXₘQ, wherein Q is an amine-containing group, X is a polyether group, and R is an aryl or alkyl group, either linear or branched, saturated or unsaturated, or a combination thereof. m and n are integers greater than or equal to 0. The compositions reduce or eliminate sheen and luster on carbon fibers in finished goods. Carbon fiber-reinforced composite materials and carbon fibers incorporating said sizing compositions are also provided.

### CROSS-REFERENCE TO RELATED APPLICATIONS

This application claims priority to, and the benefit of, U.S. Provisional Application Serial No. 63/380,657, filed Oct. 24, 2022, which is hereby incorporated herein by reference in its entirety for all purposes.

### FIELD

The present invention relates generally to sizing compositions, and more particularly, to sizing compositions comprising epoxy-containing resins and carboxylate salts of amine compounds as latent epoxy cures for the treatment of carbon fiber.

### BACKGROUND

Carbon fibers have been used in a wide variety of structural applications and industries because of their desirable properties. For example, carbon fibers can be formed into a structural component that combines high strength and high stiffness, while having a weight that is significantly lighter than a metal component of equivalent properties. One common method of preparing carbon fibers involves converting a polyacrylonitrile (PAN) precursor fiber, in a multi-step process in which the precursor fiber is heated, oxidized, and carbonized to produce a fiber that is 90% or greater carbon. The resulting carbon fibers can be molded into high strength composite materials for structural applications, used in their pure form for electrical and friction applications, or can be further processed for use in adsorbent, filter, or other applications. In particular, composite materials have been developed in which carbon fibers serve as a reinforcing material in a resin, ceramic, or metal matrix.

At the end of the carbon fiber manufacturing process, a sizing material is typically applied to the carbon fiber. This sizing material, also referred to as sizing or just size, helps to protect the carbon fiber filaments during subsequent handling, weaving, and processing. The sizing may also provide compatibility with the matrix resin used in the process to make the composite material.

Often, in cosmetic applications of carbon fiber-based prepregs and woven fabrics, the appearance of these carbon-based materials is of utmost importance, and sometimes outweighs strength performance and other composite mechanical characteristics. Herein, the term “cosmetic application” indicates an application in which a customer can observe the appearance of carbon fiber in a finished product. Examples of such applications can be found in carbon fiber-based woven fabrics or prepregs used in consumer electronics (such as laptop bodies), automotive applications and sporting goods. The occurrence of a variety of visual defects is well known in this field of applications and highly undesirable. One of such defects is termed as “stripes” herein and is manifested by an apparent difference in darkness variation on a tow level, from one tow to another, that becomes especially apparent in woven items.

There are several plausible causes for such variation within the material, some of which can be attributed to contamination, sizing amount variation on the fiber, etc. Whether these causes are natural or unnatural, such variation in appearance of fiber in finished goods is highly undesirable. These effects are especially vivid in fibers that have a brighter/glossy appearance due to high sheen or luster on the fiber. It is, therefore, advantageous to eliminate sheen or luster in carbon fiber tows in such applications. In addition, it is sometimes desirable for the appearance of the fiber or fiber woven product to be as dark as possible, without gloss, for aesthetic reasons.

Accordingly, there still exists a need for improved sizing agent compositions which can eliminate sheen or luster, and improve uniformity between carbon fiber tows in composite materials.

### SUMMARY

It has unexpectedly been found that when an epoxy-containing size is combined with the carboxylate salt of an amine and cured/dried at certain temperature on carbon fiber, the cosmetic appearance of a carbon fiber, and composite materials comprising said carbon fiber, can be improved.

An embodiment of the invention is a sizing composition comprising:
an epoxy-containing resin; and
a carboxylate salt of an amine, wherein the amine has the formula

RₙXₘQ
wherein:
   Q is an amine-containing group, comprising at least one primary or secondary amine;
   X is a polyether group selected from the group consisting of poly(propylene oxide) (PPO) and poly(ethylene oxide) (PEO) or a mix thereof;
   m is an integer, where m≥0;
   R is an aryl or alkyl group, wherein each alkyl group may be independently linear or branched, and wherein each alkyl group may independently be saturated or unsaturated; R contains from 0-10 heteroatoms; and R is either unsubstituted or substituted with 1 -5 substituents selected from the group consisting of C₁-C₁₂ alkyl groups, C₁-C₁₂ heteroalkyl groups, C₆-C₁₄ aryl groups, and C₆-C₁₄ heteroaryl groups; and
   n is an integer, with n≥0.

Another embodiment of the invention is a carbon fiber prepared by having a composition as described above dried and cured on a surface thereof.

Another embodiment of the invention is a method of treating a carbon fiber, comprising applying a sizing composition as described above to a carbon fiber, to form a coating thereon.

Another embodiment of the invention is a carbon fiber-reinforced composite comprising a carbon fiber as described above.

### BRIEF DESCRIPTION OF THE FIGURES

FIG. 1 depicts a comparison of grayscale darkness values, at different angles of observation, for a control fiber and certain darker experimental fibers.

FIG. 2 depicts the different zones within each fiber used to calculate median grayscale values for the sake of comparison.

### DETAILED DESCRIPTION

The present inventions now will be described more fully hereinafter. These inventions may be embodied in many different forms and should not be construed as limited to the embodiments set forth herein; rather, these embodiments are provided so that this disclosure will satisfy applicable legal requirements. Like numbers refer to like elements throughout. As used in the specification, and in the appended claims, the singular forms “a”, “an”, “the”, include plural referents unless the context clearly dictates otherwise. All patents and patent application publications are hereby incorporated by reference in their entireties.

### I. Definitions

For the purposes of the present application, the following terms shall have the following meanings:

The terms “sizing material,” “sizing agent,” “sizing,” and “size” refer to a material applied to a carbon fiber for the purpose 1) improving the handing, weaving, and/or processing of the carbon fiber and/or 2) improving the compatibility of the carbon fiber with the matrix in a composite material.

The term “fiber” can refer to a fiber of finite length or a filament of infinite length.

The term “precursor fiber” refers to a fiber comprising a polymeric material that can, upon the application of sufficient heat, be converted into a carbon fiber having a carbon content that is about 85% or greater, and in particular about 95% or greater, by weight. The precursor fiber can comprise both homopolymers and copolymers of acrylonitrile (AN), and may include vinyl copolymers such as methyl acrylate (MA), methacrylic acid (MAA), sodium methallylsulfonate, itaconic acid (IA), vinyl bromide (VB), isobutyl methacrylate (IBMA), and combinations thereof. In one embodiment, the precursor fiber comprises a polyacrylonitrile (PAN) polymer formed primarily from acrylonitrile monomers.

The term “grayscale” is a numeric method of conveying the darkness of an object, on a scale of 0 (black) to 255 (white). Numbers in between these values refer to varying shades of gray, where numbers closer to 0 are darker and numbers closer to 255 are lighter.

The PAN precursor fibers are typically prepared by melt spinning or by solvating the precursor polymers in organic and/or inorganic solvents such as dimethylsulfoxide, dimethyl formamide, zinc chloride or sodium thiocyanate solutions to form a spinning solution. For example, the spinning solution may be formed from water, acrylonitrile polymer and sodium thiocyanate at exemplary respective weight ratios of about 60:10:30. This solution can then be concentrated through evaporation and filtered to provide the spinning solution. The spinning solution is passed through spinnerets using various spinning processes, such as dry, dry/wet or wet spinning, to form the polyacrylonitrile precursor fiber. After exiting from the spinneret, the spun filaments are washed. In some embodiments, the spun filaments can be stretched up to several times their original length in hot water and steam. After the fibers have been washed, before and/or after the stretching, they are typically subjected to a finishing step, where spin finish is applied to the fibers to protect the fibers in subsequent processing steps.

The terms “about” and “substantially” as used herein means a deviation (plus/minus) of less than 10%, and in particular, less than 5%, less than 4%, less than 3%, and less than 2% of the recited value. It is understood that where a parameter range is provided, all integers and ranges within that range, and tenths and hundredths thereof, are also provided by the embodiments. For example, “5-10%” includes 5%, 6%, 7%, 8%, 9%, and 10%; 5.0%, 5.1%, 5.2% . . . 9.8%, 9.9%, and 10.0%; and 5.00%, 5.01%, 5.02% . . . 9.98%, 9.99%, and 10.00%, as well as, for example, 6-9%, 8-10%, 5.1%-9.9%, and 5.01%-9.99%. Similarly, where a list is presented, unless stated otherwise, it is to be understood that each individual element of that list, and every combination of components of that list, is a separate embodiment. For example, “1, 2, 3, 4, and 5” encompasses, among numerous embodiments, 1; 2; 3; 1 and 2; 3 and 5; 1, 3, and 5; and 1, 2, 4, and 5.

The term “carboxylic salt” of an amine refers to a compound created by reacting a carboxylic acid with an amine-containing compound. As used herein, it means that all primary and/or secondary amines present have been reacted and converted to their corresponding carboxylate salts.

The term “epoxy-containing resin” refers to any resin made from monomers containing at least one epoxide group. In an embodiment, the epoxy-containing resin is an epoxy resin.

An embodiment of the invention is a sizing composition comprising:
an epoxy-containing resin; and
a carboxylate salt of an amine, wherein the amine has the formula

RₙXₘQ
wherein:
   Q is an amine-containing group, comprising at least one primary or secondary amine;
   X is a polyether group selected from the group consisting of poly(propylene oxide) (PPO) and poly(ethylene oxide) (PEO) or a mix thereof;
   m is an integer, where m≥0;
R is an aryl or alkyl group, wherein each alkyl group may be independently linear or branched, and wherein each alkyl group may independently be saturated or unsaturated; R contains from 0-10 heteroatoms; and R is either unsubstituted or substituted with 1-5 substituents selected from the group consisting of C₁-C₁₂ alkyl groups, C₁-C₁₂ heteroalkyl groups, C₆-C₁₄ aryl groups, and C₆-C₁₄ heteroaryl groups; and
n is an integer, with n≥0.

In an embodiment, Q is a monoamine. In an embodiment, Q comprises a plurality of amino groups. In an embodiment, Q comprises a plurality of primary or secondary amino groups. In an embodiment, Q comprises an epoxy-amine adduct.

In an embodiment, X comprises PPO. In an embodiment, X comprises PEO.

In an embodiment, m≥1, m≥2, or m≥3.

In an embodiment, X is absent.

In an embodiment, at least one R is linear. In an embodiment, at least one R is branched. In an embodiment, at least one R is saturated. In an embodiment, at least one R is unsaturated. In an embodiment, R is unsubstituted. In an embodiment, R is substituted.

In an embodiment, n≥2, or n≥3. In an embodiment, n is 0-20. In an embodiment, n is at least, at most, or about 0, 1, 2, 3, 4, 5, 6, 7, 8, 9, 10, 11, 12, 13, 14, 15, 16, 17, 18, 19, or 20, or within a range defined by any two of these values.

In an embodiment, the carboxylic salt is derived from a monocarboxylic acid. In an embodiment, the carboxylic salt is derived from a polycarboxylic acid. In an embodiment, the carboxylic salt is derived from a polycarboxylic acid derivative with at least one free/unmodified acid group.

An embodiment of the invention is a carbon fiber prepared by having a composition as described above dried and cured on a surface thereof. Following the drying and curing, the carboxylate salt may not be present in the coating. An embodiment of the invention is a carbon fiber-reinforced composite comprising a carbon fiber as described above. In an embodiment, the carbon fiber-reinforced composite comprises a resin matrix infused into the fiber.

An embodiment of the invention is a method of preparing a treated carbon fiber, said method comprising the steps of:
i) applying a sizing composition as described above to a carbon fiber, thereby forming a coated carbon fiber;
ii) drying the coated carbon fiber, and
iii) curing the coated carbon fiber;
   so as to form a treated carbon fiber.

Step i) is generally performed at or about room temperature (approximately 20-25° C.), but this is not a requirement. Step i) is also typically performed by submerging the fiber, or a fabric comprising a plurality of fibers, in a bath comprising the sizing composition. In an embodiment, step i) is performed for about 5 seconds to about 60 seconds. In an embodiment, step i) is performed for at least, at most, or about 5, 10, 15, 20, 25, 30, 35, 40, 45, 50, 55, or 60 seconds, or within a range defined by any two of these values.

In an embodiment, step ii) is performed at a temperature between about 100° C. and about 190° C. In an embodiment, step ii) is performed at a temperature of at least, at most, or about 100, 105, 110, 115, 120, 125, 130, 135, 140, 145, 150, 155, 160, 165, 170, 175, 180, 185, or 190° C., or within a range defined by any two of these values.

In an embodiment, step ii) is performed for about 15 seconds to about 5 minutes. In an embodiment, step ii) is performed for at least, at most, or about 15 seconds, 30 seconds, 45 seconds, 1 minute, 1.5 minutes, 2 minutes, 2.5 minutes, 3 minutes, 3.5 minutes, 4 minutes, 4.5 minutes, or 5 minutes, or within a range defined by any two of these values.

In an embodiment, step iii) is performed at a temperature between about 100° C. and about 190° C. In an embodiment, step iii) is performed at a temperature of at least, at most, or about 100, 105, 110, 115, 120, 125, 130, 135, 140, 145, 150, 155, 160, 165, 170, 175, 180, 185, or 190° C., or within a range defined by any two of these values. The term “curing” does not require 100% curing, and encompasses partial curing.

In an embodiment, step iii) is performed for about 15 seconds to about 5 minutes. In an embodiment, step iii) is performed for at least, at most, or about 15 seconds, 30 seconds, 45 seconds, 1 minute, 1.5 minutes, 2 minutes, 2.5 minutes, 3 minutes, 3.5 minutes, 4 minutes, 4.5 minutes, or 5 minutes, or within a range defined by any two of these values.

In an embodiment, step ii) and step iii) are performed concurrently. In an embodiment, step ii) and step iii) are performed consecutively (such as, for example, when the coated fiber is dried at a temperature less than the temperature necessary for curing). When step i) is performed by submerging a carbon fiber or a fabric comprising a plurality of carbon fibers in a bath comprising the sizing solution, the fiber or fabric will be removed from the bath prior to performing steps ii) and iii).

### 1. Epoxy Resin

The epoxy resin used in the sizing compositions of the invention may be any epoxide-containing material known in the art. In an embodiment, the epoxy resin is an epoxy-containing copolymer, such as epoxy methacrylate, epoxy acrylate, epoxy ester and siloxane epoxy copolymers. In an embodiment, the epoxy-containing copolymer is an epoxy/urethane copolymer.

Examples of suitable epoxies include those disclosed in U.S. Pat. Nos. 4,409,288 and 6,013,730 and US 2013/0224470, which are hereby incorporated by reference in their entireties. In an embodiment, the epoxy resin is bisphenol-based. In an embodiment, the epoxy resin is bisphenol A-based. In an embodiment, the epoxy resin is bisphenol F-based. In an embodiment, the epoxy resin is bisphenol S-based. In an embodiment, the epoxy resin is a glycidyl amine. In an embodiment, the epoxy resin is a novolak. In an embodiment, the epoxy resin is aliphatic. In an embodiment, the epoxy resin is halogenated.

Specific epoxy resins suitable for use in the present invention include:
Bisphenol A based: EPON 828, EPON 825, EPON 826, EPON 830, Epon 834 (Hexion), DER 332 (Dow Chemical), Tactix 123 and Tactix 138 (Huntsman).
Bisphenol F based: Araldite GY 281/282/285 (Huntsman) and Rutapox 0158 (Bakelite).
Epoxyphenol novolac-based: DEN 431, DEN 428, DEN 439 (Dow Chemical), EPN 1138 and EPN 1139 (Huntsman).
Glycidyl amines: Araldite MY 9512, Araldite MY 721 and Araldite MY 720 (Huntsman).
Halogenated (brominated): Araldite LT 8049 (Huntsman, DER 542 (Dow Chemical).
Alicyclic epoxies: CY179-1 (Diacel), Araldite 175 (Huntsman) and Epalloy 5000 (Huntsman).

Examples of the compounds having epoxy groups and urethane groups include urethane-modified epoxy resins. Examples include EPU-78-135, EPU-6, EPU-11, EPU-15, EPU16A, EPU-16N, EPU-17T-6, EPU-1348 and EPU-1395 (Adeka Corporation) and Hydran CF-025 (DIC Corporation).

### 2. Amines

The structure of the amine used to make salts of the invention can be described by the general formula:

RₙXₘQ
wherein:
Q is an amine-containing group, either having a plurality of amines or a single amino-group. In either case it is important that at least one primary or secondary amine is present. Non-limiting examples include monoamines, polyamines, and polyamidoamines. Q may also be an epoxy-amine adduct. The amine comprises either R or X groups independently or by a combination thereof. Generally, the above formula describes classes of amine-containing compounds used as cures for epoxy resins, known in the art.
X is a polyether group selected from the group consisting of poly(propylene oxide) (PPO) compounds and poly(ethylene oxide) (PEO) compounds, or a mix thereof. In an embodiment, X comprises PPO. In an embodiment, X comprises PEO. In an embodiment, X is a blend of PPO and PEO. In an embodiment, each X comprises 2-50 propylene oxide and/or ethylene oxide monomer units. In an embodiment, each X comprises 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 propylene oxide and/or ethylene oxide monomer units. In an embodiment, each X comprises at least 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 propylene oxide and/or ethylene oxide monomer units. In an embodiment, each X comprises at most 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, or 49 propylene oxide and/or ethylene oxide monomer units.
m is an integer, where m≥0.
R is an aryl or alkyl group, either linear or branched, saturated or unsaturated, or a combination thereof. In an embodiment, the aryl group is a C₆-C₁₄ aryl group. In an embodiment, the aryl group is selected from the group consisting of phenyl, benzyl, tolyl, xylyl, and napthyl.

In an embodiment, the alkyl group is a C₁-C₂₄ alkyl group. In an embodiment, the alkyl group is a C₁, C₂, C₃, C₄, C₅, C₆, C₇, C₈, C₉, C₁₀, C₁₂, C₁₂, C₁₃, C₁₄, C₁₅, C₁₆, C₁₇, C₁₈, C₁₉, C₂₀, C₂₁, C₂₂, C₂₃, or C₂₄ alkyl group. In an embodiment, the alkyl group is at least a C₁, C₂, C₃, C₄, C₅, C₆, C₇, C₈, C₉, C₁₀, C₁₂, C₁₂, C₁₃, C₁₄, C₁₅, C₁₆, C₁₇, C₁₈, C₁₉, C₂₀, C₂₁, C₂₂, or C₂₃ alkyl group. In an embodiment, the alkyl group is at most a C₂, C₃, C₄, C₅, C₆, C₇, C₈, C₉, C₁₀, C₁₂, C₁₂, C₁₃, C₁₄, C₁₅, C₁₆, C₁₇, C₁₈, C₁₉, C₂₀, C₂₁, C₂₂, C₂₃, or C₂₄ alkyl group.

R may be substituted with 1-5 substituents each independently selected from the group consisting of C₁-C₁₂ alkyl groups, C₁-C₁₂ heteroalkyl groups, C₆-C₁₄ aryl groups, and C₆-C₁₄ heteroaryl groups. C₁-C₁₂ heteroalkyl groups include, for example, C₁-C₁₂ alkyloxy groups, C₁-C₁₂ alkylamino groups, and C₁-C₁₂ haloalkyl groups.

R can contain 1-10 heteroatoms, in its main chain (i.e., the alkyl or aryl) and/or substituents. A heteroatom is any atom other than C or H. Non-limiting examples of such heteroatoms are N, O, P, and S. R may also contain no heteroatoms.

n is an integer, with n≥0. If n≥2, then each instance of R does not need to be identical to the others.

It is understood that when m is 0, X is absent, and that when n is 0, R is absent.

It is also understood that RₙXₘQ is not a structural formula, in that at least one R group may be bound directly to Q, even when X is present.

### 3. Carboxylic Acids

Carboxylic acids used to make such carboxylate amine salts are not limited to any class, and can be, for example, either monocarboxylic or polycarboxylic acids substituted or unsubstituted. Derivatives of polycarboxylic acids can be also used.

In some embodiments, the carboxylic acid is a monocarboxylic acid. Examples of monocarboxylic acids include formic acid, acetic acid, propionic acid, butyric acid, isobutyric acid, valeric acid, isovaleric acid, caproic acid, etc., or a hydroxycarboxylic acid , such as glycolic acid, lactic acid, etc. These monocarboxylic acids may be used either alone or as a mixture of 2 or more thereof.

In one embodiment, the carboxylic acid is a dicarboxylic acid. In an embodiment, the dicarboxylic acid has the following formula:

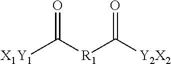

wherein R₁ is absent or a saturated or unsaturated, linear or branched, aromatic, substituted or unsubstituted, hydrocarbon group;
Y₁ and Y₂ are independently a nitrogen, oxygen, sulfur or phosphorus containing group, C₁-C₆ alkyl groups, alkoxy groups, and/or phenyl groups.
X₁ and X₂ are independently a hydrogen, a metal, a quaternary amine, an alcohol, or a hydrocarbon group having up to 6 carbon atoms, the hydrocarbon group being an alkyl group, an alkylene group, or an aromatic group, which may be branched or linear, and may optionally have one or more heteroatoms selected from the group consisting of nitrogen, oxygen, sulfur and phosphorus.

Examples of metals for X₁ and X₂ include alkali metals, such as lithium, potassium, and sodium.

By way of guidance, some examples of possible embodiments of R₁ are provided below in which R₁ is selected from a hydrocarbon having any one or more of the following:
a saturated, linear or branched alkyl chain substituted with one or more of nitrogen, oxygen, sulfur or phosphorus containing groups (examples of such groups include carbonyls, ethers, amides, amines, alcohols, and the like);
an unsaturated, branched or linear alkyl group;
an unsaturated, branched or linear alkyl group substituted with one or more of nitrogen, oxygen, sulfur or phosphorus containing groups, (examples of such groups include carbonyls, ethers, amides, amines, alcohols, and the like);
one or more polyethylene glycol or polypropylene glycol groups;
an aromatic group that is optionally substituted with one or more of an alkyl group, a nitrogen containing group, an oxygen containing group, a sulfur containing group, or a phosphorous containing group (examples of such groups include carbonyls, ethers, amides, amines, alcohols, and the like); and
one or more of an alkene, alkyne, alcohol, carbonyl, ether, amine, amide, phenyl, benzene, furan, pyridine, or pyran group, or imidazole group.

In some embodiments, R₁ may also include combinations of the foregoing exemplary hydrocarbon groups. It should also be recognized that in some embodiments R₁ may be absent.

Examples of dicarboxylic acids that may be used in certain embodiments of the invention include DL-Tartaric acid, L-Tartaric acid, D-Tartaric acid, fumaric acid, mesaconic acid, oxamic acid, succinic acid, 2-methyl succinic acid, L-malic acid, DL-malic acid, D-malic acid, aspartic acid, mesoxalic acid, muconic acid, oxaloacetic acid, glutamic acid, diglycolic acid, iminodiactetic acid, 2,2′-oxydipropanoic acid, 3,3′ -oxydipropanoic acid, 2,2′-[1,2-ethanediylbis(oxy)]bis-acetic acid, 3,3-[1,2-ethanediylbis(oxy)]bis-propanoic acid, 3,3′-[oxybis(ethane-2,1-diyloxy)]dipropanoic acid, poly(ethylene glycol)bis-acetic acid, polyethylene glycol bis(carboxymethyl) ether, polyehtylene glycol diacid 600, chelidonic acid, dipicolinic acid, 2,5-furandicarboxylic acid, isophthalic acid, terephtalic acid, orthophthalic acid, trimesic acid, 1,4-phenylene diacetic acid, 1,3-phenylene diacetic acid and their derivatives, such as, ammonium tartrate dibasic, potassium tartrate monobasic, ammonium hydrogenoxalate, monomethyl fumarate, and monoethyl fumarate, and mixtures thereof.

In some embodiments, the dicarboxylic acid may comprise a ketoacid, such as one or more of the following: hydroxypyruvic acid, alpha-ketoglutaric and beta-ketoglutaric, alpha-ketoadipic acid, α-ketovaleric acid, levulinic acid, 4-hydroxy-2-oxopentanoic acid, and 4-hydroxyphenylpyruvic acid.

### 4. Surfactants

The sizing composition may also include a surfactant. The surfactant is not specifically restricted, and can be selected from nonionic, anionic, cationic and amphoteric surfactants known to those skilled in the art. One of or a combination of at least two of such emulsifiers can be used.

The nonionic surfactants include, for example, linear polyoxyalkylene alkylethers, such as polyoxyethylene hexyl ether, polyoxyethylene octyl ether, polyoxyethylene decyl ether, polyoxyethylene lauryl ether and polyoxyethylene cetyl ether; branched polyoxyalkylene primary alkyl ethers, such as polyoxyethylene 2-ethylhexyl ether, polyoxyethylene isocetyl ether and polyoxyethylene isostearyl ether; branched polyoxyalkylene secondary alkyl ethers, such as polyoxyethylene 1-hexylhexyl ether, polyoxyethylene 1-octylhexyl ether, polyoxyethylene 1-hexyloctyl ether, polyoxyethylene 1-pentylheptyl ether and polyoxyethylene 1-heptylpentyl ether; polyoxyalkylene alkenyl ethers, such as polyoxyethylene oleyl ether; polyoxyalkylene alkylphenyl ethers, such as polyoxyethylene octylphenyl ether, polyoxyethylene nonylphenyl ether, and polyoxyethylene dodecylphenyl ether; polyoxyalkylene alkylarylphenyl ethers, such as polyoxyethylene tribenzyl phenyl, polyoxyethylene dibenzylphenyl ether, and polyoxyethylene benzylphenyl ether; polyoxyalkylene fatty acid esters, such as polyoxyethylene monolaurate, polyoxyethylene monooleate, polyoxyethylene monostearate, polyoxyethylene monomyristylate, polyoxyethylene dilaurate, polyoxyethylene dioleate, polyoxyethylene dimyristylate, and polyoxyethylene distearate; sorbitan esters, such as sorbitan monopalmitate and sorbitan monooleate; polyoxyalkylene sorbitan fatty acid esters, such as polyoxyethylene sorbitan monostearate and polyoxyethylene sorbitan monooleate; glycerin fatty acid esters, such as glycerin monostearate, glycerin monolaurate and glycerin monopalmitate; polyoxyalkylene sorbitol fatty acid esters; sucrose fatty acid esters; polyoxyalkylene castor oil ethers, such as polyoxyethylene castor oil ether; polyoxyalkylene hydrogenated castor oil ethers, such as polyoxyethylene hydrogenated castor oil ether; polyoxyalkylene alkyl aminoethers, such as polyoxyethylene lauryl aminoether and polyoxyethylene stearyl aminoether; oxyethylene-oxypropylene block or random copolymers; terminally alkyletherified oxyethylene-oxypropylene block or random copolymers; and terminally sucrose-etherified oxyethylene-oxypropylene block or random copolymers.

Of those nonionic surfactants, branched polyoxyalkylene primary alkylethers, branched polyoxyalkylene secondary alkylethers, polyoxyalkylene alkenyl ethers, polyoxyalkylene alkylphenyl ethers, polyoxyalkylene fatty acid esters, oxyethylene-oxypropylene block copolymers and terminally alkyletherified oxyethylene-oxypropylene block copolymers are preferable for their excellent performance to emulsify silicone compounds in water. Furthermore, oxyethylene-oxypropylene block or random copolymers and terminally alkyletherified oxyethylene-oxypropylene block copolymers are more preferable for their performance to change into a tarry substance on fiber in baking process so as to protect fiber from damage.

The anionic surfactants include salts of various acids, such as salts of fatty acids, salts of hydroxyl-group-containing carboxylic acids, such as hydroxyacetic acid, potassium hydroxyacetate, lactic acid and potassium lactate; salts of polyoxyalkylene alkylether acetic acids, such as the sodium salt of polyoxyalkylene tridecyl ether acetic acid; salts of carboxyl-polysubstituted aromatic compounds, such as potassium trimellitate and potassium pyromellitate; slats of alkylbenzene sulfonic acids, such as salts of dodecylbenzene sulfonic acid; salts of polyoxyalkylene alkylether sulfonic acids, such as salts of polyoxyethylene 2-ethylhexyl ether sulfonic acids; salts of higher fatty acid amide sulfonic acids, such as salts of stearoyl methyltaurine, salts of lauroyl methyltaurine, salts of myristoyl methyltaurine and salts of palmitoyl methyltaurine; salts of N-acyl sarcosine acids, such as salts of lauroyl sarcosine acid; salts of alkyl phosphonic acids, such as salts of octyl phosphonate, salts of aromatic phosphonic acids, such as the potassium salt of phenyl phosphonate; salts of alkyl phosphonic acid alkyl phosphates, such as salts of 2-ethylhexyl phosphonate mono-2-ethylhexyl ester; salts of nitrogen-containing alkyl phosphonic acids, such as salts of aminoethyl phosphonic acid and its diethanol amine salt; salts of alkyl sulfates, such as salts of 2-ethylhexyl sulfate; salts of polyoxyalkylene sulfates, such as salts of polyoxyethylene 2-ethylhexyl ether sulfate; salts of long-chain sulfosuccinate salts, such as sodium di-2-ethylhexyl sulfosuccinate and sodium dioctyl sulfosuccinate; and long-chain N-acyl glutamates, such as monosodium N-lauroyl glutamate and disodium N-stearoyl-L-glutamate. Anionic surfactants may also include alkyl and aryl phosphoric acids and their derivatives.

The cationic surfactants include, for example, quaternary ammonium salts, such as lauryltrimethyl ammonium chloride and oleylmethylethyl ammonium ethosulfate; and (polyoxyalkylene) alkylaminoether salts, such as (polyoxyethylene) lauryl aminoether lactate salt, stearyl aminoether lactate salt, and (polyoxyethylene) lauryl aminoether trimethyl phosphate salt.

The amphoteric emulsifiers include, for example, imidazoline amphoteric surfactants, such as sodium 2-undecyl-N,N-(hydroxyethy1 carboxymethyl)-2-imidazolinate and disodium 2-cocoyl-2-imidazolinium hydroxyde-1-carboxyethyloxiate; betaine amphoteric surfactants, such as 2-heptadecyl-N-carboxymethyl-N-hydroxyethyl imidazolium betaine, lauryldimethyl aminoacetic acid betaine, alkyl betaine, amidobetaine and sulfobetaine; and amino acid amphoteric surfactants, such as N-lauryl glycine, N-lauryl-β-alanine and N-stearyl-β-alanine.

### 5. Viscosity Modifiers

In some embodiments, the sizing composition may include one or more viscosity modifiers. In general, the viscosity modifier includes any composition that desirably modifies the viscosity without inhibiting the effect of the present invention. Viscosity modifiers may include natural polymers such as starch, cellulose, alginate, agar, carrageenan, collagen, gelatin, guar gum, and xanthan gum. Examples of cellulose polymers may include methyl cellulose, hydroxypropyl methyl cellulose, ethyl cellulose, hydroxyethyl cellulose, and carboxy methyl cellulose. Viscosity modifiers may also include synthetic acrylic-based polymers such as alkali-swellable (or soluble) emulsions (ASE's) hydrophobically modified alkali-swellable emulsions (HASE's) and hydrophobically modified, ethoxylated urethane resins (HEUR's). In some embodiments, the viscosity modifier may comprise an aminocarboxylic material, such as carboxylic acid salts of alkylamines, carboxylic acid salts of arylamines, carboxylic acid salts of alkylarylamines, amino acids and betaine compounds.

### 6. Additional Components

In addition to the above mentioned components, the sizing composition of the present invention may further contain components so far as those components do not inhibit the effect of the present invention. Those components may include antioxidants, such as phenolic, amine, sulfur, phosphorus or quinone compounds; antistats, such as sulfate salts of higher alcohol or higher alcoholic ethers, sulfonate salts, phosphate salts of higher alcohol or higher alcoholic ethers, lubricants, such as polyethylene glycol, polyvinyl alcohol, alkyl esters of higher alcohol, ethers of higher alcohol, and waxes; antibacterial agents; antiseptics; anticorrosive agents; and hygroscopic agents. In some embodiments, the lubricant may comprise a polyethylene glycol with an average molecular weight between 100 and 10,000. More preferrable, the lubricant may comprise a polyethylene glycol with an average molecular weight between 800 and 8000. In a preferred embodiment, the lubricant may comprise a polyethylene glycol with an average molecular weight between 1000 and 2000. In an embodiment, polyethylene glycol is present in the composition in an amount of between 1-40% by weight, compared to the total weight of the solids in the sizing composition.

In an embodiment, the carboxylate salt is present in the composition in an amount of about 0.01% to about 80%, by weight, compared to the total weight of the solids in the sizing composition. In an embodiment, the carboxylate salt is present in the composition in an amount of less than, greater than, or about 0.01%, about 0.05%, about 0.1%, about 0.2%, about 0.3%, about 0.4%, about 0.5%, about 0.6%, about 0.7%, about 0.8%, about 0.9%, about 1%, about 1.1%, about 1.2%, about 1.3%, about 1.4%, about 1.5%, about 1.6%, about 1.7%, about 1.8%, about 1.9%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, or about 80%, by weight.

### Discussion

Fiber appearance (cosmetic) issues as “stripes” or other visual inconsistencies mentioned above are normally resolved by implementing engineering controls in Production, such as better sizing content control on a fiber and avoidance of contaminants.

Amine-based curing agents are commonly used for curing epoxy resins. They have also been added to epoxy sizing to improve the properties of carbon fiber-vinyl ester composites as taught in US 2013/0224470. These curing agents consist of polyamines containing primary and secondary amine groups. This reference does not teach the use of amine carboxylate salts as latent cross-linking agents for epoxy materials. The un-inhibited polyamines, the use of which is taught in these documents, are not suitable for conventional production due to their excessive reactivity toward epoxy groups in sizings even at ambient temperatures that brings about severe complications, such as gelling of sizing emulsions in sizing baths and build-up on dryer roll surfaces due to formation of highly insoluble, sticky, partially cured epoxy materials with time.

JP2013127132 A teaches the use of salts of tertiary amines to improve matrix adhesion to carbon fibers. However, in addition to the fact that the effect of addition of these salts on fiber tow appearance is not discussed, the present Comparative Example 3 shows that tertiary amines are not effective in rendering tows darker due to their inability to participate in cross-linking reactions with epoxies.

The present inventors discovered that “darkness” of carbon fiber filaments generally depends on two parameters: filament surface roughness in unsized state and sizing morphology/distribution in sized state. Whereas it is very difficult to change and control pristine carbon fiber surface roughness in a manner that can be repeatedly reproduced in production settings, sizing morphology/distribution can be changed and controlled more easily. The inventors also discovered that decreasing the brightness/gloss of the sized tows and rendering them darker is very desirable and advantageous in terms of masking aforementioned visual defects. Through diligent research, it was discovered that usage of certain latent amine-based curing agents in epoxy-containing sizes can lead to much darker carbon fiber tow appearance upon curing of the size that solves the aforementioned problem.

As shown below, it was discovered that a certain structure of carboxylate salts of amine-containing cures is especially effective in decreasing sheen/gloss of the fiber tow and rendering a darker appearance to the latter, when used in epoxy-containing carbon fiber sizes.

Both from Table 1 and Table 2 and examples therein, it can be seen that tow darkness can be effectively increased by the addition of latent amine-based cures to an epoxy sizing formulation, applying it to the fiber and drying/curing at selected temperature. The final drying temperature may be selected to enable the curing of the epoxy-containing formulation. The final drying temperature may also be selected to be higher than the curing peak temperature obtained by DSC experiment. The final drying temperature may also be selected to be 1 to 50° C. higher than the curing peak temperature obtained by DSC experiment. The final drying temperature may also be selected to be 5 and 40° C. higher than the curing peak temperature obtained by DSC experiment.

The grayscale peak value difference of 10 can be usually discerned by a naked eye; therefore, a grayscale peak value of at least 125 is desired, a grayscale peak value of 115 is more desired, and a grayscale peak value of below 105 is especially desired. As can be seen from the Comparative examples, most of the uninhibited (i.e., non-carboxylated) amine cures investigated worked, in terms of rendering fibers dark, but they were too reactive to be used in Production settings (as mentioned above), which can be seen when comparing DSC onset/peak cure temperatures of, for example, Comparative Example 5 (uninhibited Aradur 3986) and Example 15 (inhibited Aradur 3986). The degree of latency of the inhibited cure depends both on the nature of the cure (type of amine groups present) and the nature of the carboxylic acid used as the inhibitor (particularly the pKa and boiling point). The degree to which one might want to inhibit amine-containing cures depends on processing parameters, such as, fiber drying temperatures after size application and nature of drying (contact drying, non-contact drying). Comparative example 2 was investigated, as a type of uninhibited cure taught in US 2013/0224470. As shown, this cure was completely ineffective in rendering fibers dark. Comparative example 3 was investigated as a type of tertiary amine additive described in JP2013127132 A. This type of cure had no effect on tow darkness, because tertiary amines cannot participate in epoxy cross-linking reactions, but only catalyze chain-extension/condensation reactions of epoxies.

It is also desirable that the amine compound has a certain degree of hydrophobicity, mainly due to the presence of R groups, described above. In cases when there is only one R group present, and that R group is aliphatic, it is preferable that it is at least C₁₂. As can be seen from comparing Examples 8 and 9, a bigger R group (C₁₈) is more effective in rendering fibers dark than smaller C₁₂ group of the amine of the otherwise same structure. It is also estimated that Aradur 340 has C₁₃ and Aradur 435 C₁₉-C₂₀ -based R groups. Without limiting the invention, it is believed that the absence of hydrophobic groups in Jeffamine M600 (Comparative example 2) makes it ineffective in rendering fibers dark. However, the effectiveness of certain amines of this type, with the R group absent, like Jeffamine M600 and O,O′-Bis(3-aminopropyl)diethylene glycol (BADG) can be somewhat improved by neutralizing them with carboxylic acids bearing hydrophobic groups, like decanoic acid (Example 13).

### EXAMPLES

HexTow® AS4C-3K (Hexcel, Stamford, CT) unsized carbon fiber tow with 3,000 filament count was used in these studies. ARADUR 340, ARADUR 435, and ARADUR 3986 amine-containing curing agents were obtained from Huntsman (Salt Lake City, UT). CARBOWAX™ SENTRY™ Polyethylene Glycol 1450 was obtained from Dow Chemical (Midland, MI). GP size emulsion was obtained from Hexcel. Toximul TA-8 (tallow amine ethoxylate) was obtained from Stepan (Northfield, IL). All other materials were obtained from Sigma-Aldrich (St. Louis, MO).

### Control and Stock Emulsion Preparation

For Control 1, Bisphenol-A epoxy-based general purpose commercial size emulsion “GP” (Hexcel) was used. For Control 2, and also to serve as a stock emulsion for the curing studies, Carbowax 1450 was combined with Control 1 emulsion at 10 wt. % relative to epoxy.

### Inhibited Amine Carboxylate Salt Preparation

Amine-containing cures were reacted and completely neutralized with an excess of carboxylic acids in water solution at 60° C. for 2 hrs. Stoichiometry was calculated either from known structures and molecular weights or from amine values of cures reported by suppliers when exact structure was not known. The extent of neutralization was checked by pH measurement. These solutions of latent cures were then added to dilute versions (1 wt. % in water) of the stock emulsion (described above) at desired amounts.

### Sizing Application and Drying/Curing

All emulsions were applied to the tow from the sizing bath at 1 wt. % concentration and dried at various temperatures either via a non-contact drying (drying tower) or contact drying (steam drum, followed by a drying tower). When simultaneous drying and curing was used, drying temperatures employed were either matching or higher than curing peak temperature determined by DSC (see next), so as to also cure the coated tow.

### Curing Temperature Determination

All emulsions were dried under vacuum at ambient temperature and a small sample ran on a DSC (Discovery, TA Instruments) in air with 5° C./min ramp rate. The peak temperature of the exothermic curing reaction was recorded, as well as the onset temperature of that transition.

### Tow Darkness Evaluation Method

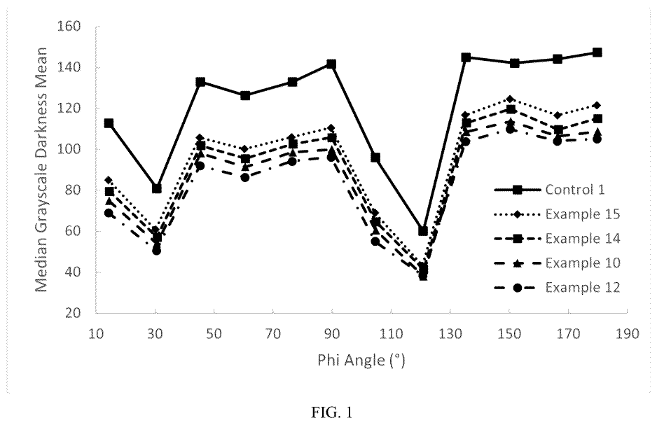

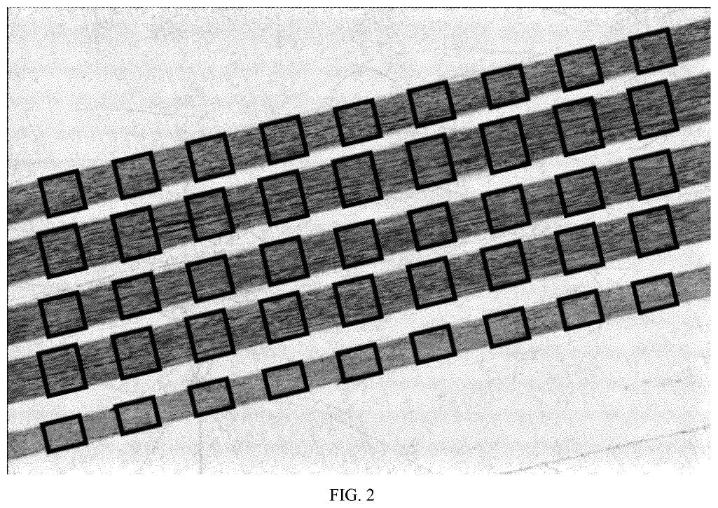

A plate was prepared with double sided tape on the face. Tows were pulled tight across the plate and pressed into the double-sided tape. Tows were imaged via a Keyence VHX-5000 with a VH-Z100R lens and an OP-72402 ring light. Rotation of the plate about the vertical axis was used for measurement at different phi angles. Mosaic images were captured with the 3D Image Stitching mode at 100× lens magnification, full ring lighting, monochrome capture mode, manual 1.00 ms shutter speed, and 0 db gain. After image capture, the images were processed through an in-house scripted Matlab workflow. 2.2 mm sections along the length of the tow and full tow width make up each measurement area. Nine areas are selected for each tow. FIG. 2 depicts example tows, with nine areas selected for each tow; this figure is provided to depict the analysis method, and is not necessarily representative of the fibers with data presented in FIG. 1 or Table 3. Grayscale values were recorded at numerous locations within each of the nine areas. For each area, either median grayscale or peak grayscale values were recorded between 0 and 255. For the peak grayscale measurement, the histogram of grayscale values was calculated, smoothed, and the maximum value from the smoothed curve is reported. The mean value of the nine values from each area is reported (Table 1). For the median grayscale measurement, the mean value was calculated for the nine areas and reported as Median Grayscale Darkness Mean in Table 3 and FIG. 1. Table 1 values were measured at 75 degree phi angle.

### Controls 1 and 2

These emulsions did not contain a curing agent. They were applied to a carbon fiber tow from 1 wt. % concentration and dried via non-contact drying (drying tower) at 125° C.

### Example 1

Amidoamine epoxy cure ARADUR 340 was inhibited by a neutralization reaction with acetic acid, at amine:acid stoichiometry 1:3. A solution of this cure was added to Control 2 emulsion to give 1:0.45 epoxy:amine salt stoichiometric ratio. The resulting emulsion was applied to a carbon fiber tow from 1 wt. % concentration and dried via non-contact drying (drying tower) at 110° C. The mean value of peak grayscale for this tow was measured and is reported in Table 1.

### Example 2

Amidoamine epoxy cure ARADUR 340 was inhibited by a neutralization reaction with fumaric acid, at amine:acid stoichiometry 1:1.25. A solution of this cure was added to Control 2 emulsion to give 1:0.45 epoxy:amine salt stoichiometric ratio. The resulting emulsion was applied to a carbon fiber tow from 1 wt. % concentration and dried via non-contact drying (drying tower) at 150° C. The mean value of peak grayscale for this tow was measured and is reported in Table 1.

### Example 3

Amidoamine epoxy cure ARADUR 340 was inhibited by a neutralization reaction with fumaric acid, at amine:acid stoichiometry 1:1.25. A solution of this cure was added to Control 2 emulsion to give 1:0.28 epoxy:mine salt stoichiometric ratio. The resulting emulsion was applied to a carbon fiber to from 1 wt. % concentration and dried via non-contact drying (drying tower) at 150° C. The mean value of peak grayscale for this tow was measured and is reported in Table 1.

### Example 4

Amidoamine epoxy cure ARADUR 340 was inhibited by a neutralization reaction with lactic acid, at amine:acid stoichiometry 1:1.1. A solution of this cure was added to Control 2 emulsion to give 1:0.36 epoxy:amine salt stoichiometric ratio. The resulting emulsion was applied to a carbon fiber tow from 1 wt. % concentration and dried via non-contact drying (drying tower) at 125° C. The mean value of peak grayscale for this tow was measured and is reported in Table 1.

### Example 5

Amidoamine epoxy cure ARADUR 340 was inhibited by a neutralization reaction with acetic acid, at amine:acid stoichiometry 1:3. A solution of this cure was added to Control 2 emulsion to give 1:0.36 epoxy:amine salt stoichiometric ratio. The resulting emulsion was applied to a carbon fiber tow from 1 wt. % concentration and dried via non-contact drying (drying tower) at 105° C. The mean value of peak grayscale for this tow was measured and is reported in Table 1.

### Example 6

Amidoamine epoxy cure ARADUR 340 was inhibited by a neutralization reaction with iminodiacetic acid, at amine:acid stoichiometry 1:1.25. A solution of this cure was added to Control 2 emulsion to give 1:0.45 epoxy:amine salt stoichiometric ratio. The resulting emulsion was applied to a carbon fiber tow from 1 wt. % concentration and dried via contact drying (steam drum) at 110° C. followed by a non-contact curing (drying tower) at 155° C. The mean value of peak grayscale for this tow was measured and is reported in Table 1.

### Example 7

Dodecyl amine was inhibited by a neutralization reaction with iminodiacetic acid, at amine:acid stoichiometry 1:1.25. A solution of this cure was added to Control 2 emulsion to give 1:0.36 epoxy:amine salt stoichiometric ratio. The resulting emulsion was applied to a carbon fiber tow from 1 wt. % concentration and dried via contact drying (steam drum) at 110° C. followed by a non-contact curing (drying tower) at 155° C. The mean value of peak grayscale for this tow was measured and is reported in Table 1.

### Example 8

Octadecylamine was inhibited by a neutralization reaction with acetic acid, at amine:acid stoichiometry 1:2. A solution of this cure was added to Control 2 emulsion to give 1:0.36 epoxy:amine salt stoichiometric ratio. The resulting emulsion was applied to a carbon fiber tow from 1 wt. % concentration and dried via non-contact drying (drying tower) at 135° C. The mean value of peak grayscale for this tow was measured and is reported in Table 1.

### Example 9

Dodecylamine was inhibited by a neutralization reaction with acetic acid, at amine:acid stoichiometry 1:2. A solution of this cure was added to Control 2 emulsion to give 1:0.36 epoxy:amine salt stoichiometric ratio. The resulting emulsion was applied to a carbon fiber tow from 1 wt. % concentration and dried via non-contact drying (drying tower) at 135° C. The mean value of peak grayscale for this tow was measured and is reported in Table 1.

### Example 10

Amidoamine epoxy cure ARADUR 435 was inhibited by a neutralization reaction with fumaric acid, at amine:acid stoichiometry 1:1.1. A solution of this cure was added to Control 2 emulsion to give 1:0.36 epoxy:amine salt stoichiometric ratio. The resulting emulsion was applied to a carbon fiber tow from 1 wt. % concentration and dried via non-contact drying (drying tower) at 160° C. The mean value of peak grayscale for this tow was measured and is reported in Table 1.

### Example 11

Amidoamine epoxy cure ARADUR 435 was inhibited by a neutralization reaction with fumaric acid, at amine:acid stoichiometry 1:1.1. A solution of this cure was added to Control 2 emulsion to give 1:0.18 epoxy:amine salt stoichiometric ratio. The resulting emulsion was applied to a carbon fiber tow from 1 wt. % concentration and dried via non-contact drying (drying tower) at 160° C. The mean value of peak grayscale for this tow was measured and is reported in Table 1.

### Example 12

Amidoamine epoxy cure ARADUR 435 was inhibited by a neutralization reaction with fumaric acid monoethyl ester, at amine:acid stoichiometry 1:1.1. A solution of this cure was added to Control 2 emulsion to give 1:0.36 epoxy:amine salt stoichiometric ratio. The resulting emulsion was applied to a carbon fiber tow from 1 wt. % concentration and dried via non-contact drying (drying tower) at 160° C. The mean value of peak grayscale for this tow was measured and is reported in Table 1.

### Example 13

O,O′-Bis(3-aminopropyl)diethylene glycol (BADG) was inhibited by a neutralization reaction with decanoic acid, at amine:acid stoichiometry 1:1.1. A solution of this cure was added to Control 2 emulsion to give 1:0.36 epoxy:amine salt stoichiometric ratio. The resulting emulsion was applied to a carbon fiber tow from 1 wt. % concentration and dried via non-contact drying (drying tower) at 125° C. The mean value of peak grayscale for this tow was measured and is reported in Table 1.

### Example 14

Epoxy-amine adduct cure ARADUR 3986 was inhibited by a neutralization reaction with iminodiacetic acid, at amine:acid stoichiometry 1:1.2. A solution of this cure was added to Control 2 emulsion to give 1:0.36 epoxy:amine salt stoichiometric ratio. The resulting emulsion was applied to a carbon fiber tow from 1 wt. % concentration and dried via non-contact drying (drying tower) at 170° C. The mean value of peak grayscale for this tow was measured and is reported in Table 1.

### Example 15

Epoxy-amine adduct cure ARADUR 3986 was inhibited by a neutralization reaction with oxamic acid, at amine:acid stoichiometry 1:1.1. A solution of this cure was added to Control 2 emulsion to give 1:0.36 epoxy:amine salt stoichiometric ratio. The resulting emulsion was applied to a carbon fiber tow from 1 wt. % concentration and dried via non-contact drying (drying tower) at 180° C. The mean value of peak grayscale for this tow was measured and is reported in Table 1.

### Example 16

Octadecylamine was inhibited by a neutralization reaction with glycolic acid ethoxylate 4-nonylphenyl ether, at amine:acid stoichiometry 1:1.5. A solution of this cure was added to Control 2 emulsion to give 1:0.36 epoxy:amine salt stoichiometric ratio. The resulting emulsion was applied to a carbon fiber tow from 1 wt. % concentration and dried via non-contact drying (drying tower) at 125° C. The mean value of peak grayscale for this tow was measured and is reported in Table 1.

### Example 17

Cure from Example 15 was used. A solution of this cure was added to Control 2 emulsion to give 1:0.52 epoxy:amine salt stoichiometric ratio. The resulting emulsion was applied to a carbon fiber tow from 1 wt. % concentration and dried via contact drying (steam drum) at 125° C. followed by a non-contact curing (drying tower) at 175° C. The mean value of peak grayscale for this tow was measured and is reported in Table 1.

### Example 18

Fiber from Example 3 was woven into a simple weave fabric of 196 gsm. 21 tows from the fill direction were analyzed for darkness and the mean value of peak grayscale is reported in Table 2.

### Example 19

Amidoamine epoxy cure ARADUR 340 was inhibited by a neutralization reaction with fumaric acid, at amine:acid stoichiometry 1:2. A solution of this cure was added to Control 2 emulsion to give 1:0.36 epoxy:amine salt stoichiometric ratio. The resulting emulsion was applied to a carbon fiber tow from 1 wt. % concentration and dried via non-contact drying (drying tower) at 150° C. This fiber was woven into a simple weave fabric of 196 gsm. 21 tows from the fill direction were analyzed for darkness and the mean value of peak grayscale is reported in Table 2.

### Example 20

Epoxy-amine adduct cure ARADUR 3986 was inhibited by a neutralization reaction with acetic acid, at amine:acid stoichiometry 1:1.1. A solution of this cure was added to Control 2 emulsion to give 1:1.5 epoxy:amine salt stoichiometric ratio. The resulting emulsion was applied to a carbon fiber tow from 1 wt. % concentration and dried via non-contact drying (drying tower) at 125° C. The mean value of peak grayscale for this tow was measured and is reported in Table 1.

### Example 21

The same sizing formulation was used as in Example 20, but the sized fiber was dried via non-contact drying (drying tower) at 160° C. The mean value of peak grayscale for this tow was measured and is reported in Table 1.

### Example 22

Epoxy-amine adduct cure ARADUR 3986 was inhibited by a neutralization reaction with acetic acid, at amine:acid stoichiometry 1:1.1. A solution of this cure was added to Control 2 emulsion to give 1:2 epoxy:amine salt stoichiometric ratio. The resulting emulsion was applied to a carbon fiber tow from 1 wt. % concentration and dried via non-contact drying (drying tower) at 125° C. The mean value of peak grayscale for this tow was measured and is reported in Table 1.

### Example 23

The same sizing formulation was used as in Example 22, but the sized fiber was dried via non-contact drying (drying tower) at 160° C. The mean value of peak grayscale for this tow was measured and is reported in Table 1.

### Comparative Example 1

Uninhibited amidoamine epoxy cure ARADUR 340 was dissolved in Control 2 emulsion to give 1:0.36 epoxy:amine stoichiometric ratio. The resulting emulsion was applied to a carbon fiber tow from 1 wt. % concentration and dried via non-contact drying (drying tower) at 125° C. The mean value of peak grayscale for this tow was measured and is reported in Table 1.

### Comparative Example 2

Uninhibited amine epoxy cure Jeffamine M-600 was dissolved in Control 2 emulsion to give 1:0.36 epoxy:amine stoichiometric ratio. The resulting emulsion was applied to a carbon fiber tow from 1 wt. % concentration and dried via non-contact drying (drying tower) at 125° C. The mean value of peak grayscale for this tow was measured and is reported in Table 1.

### Comparative Example 3

Uninhibited tertiary amine-based emulsifier Toximul TA-8 was dissolved in Control 2 emulsion to give 1:0.36 epoxy:amine stoichiometric ratio. The resulting emulsion was applied to a carbon fiber tow from 1 wt. % concentration and dried via non-contact drying (drying tower) at 160° C. The mean value of peak grayscale for this tow was measured and is reported in Table 1.

### Comparative Example 4

Uninhibited amidoamine epoxy cure ARADUR 435 was dissolved in Control 2 emulsion to give 1:0.36 epoxy:amine stoichiometric ratio. The resulting emulsion was applied to a carbon fiber tow from 1 wt. % concentration and dried via non-contact drying (drying tower) at 125° C. The mean value of peak grayscale for this tow was measured and is reported in Table 1.

### Comparative Example 5

Uninhibited amine-epoxy condensate cure ARADUR 3986 was dissolved in Control 2 emulsion to give 1:0.36 epoxy:amine stoichiometric ratio. The resulting emulsion was applied to a carbon fiber tow from 1 wt. % concentration and dried via non-contact drying (drying tower) at 125° C. The mean value of peak grayscale for this tow was measured and is reported in Table 1.

### Comparative Example 6

Carbon fiber sized with “GP” size (Control 1) from Table 1 was woven into a simple weave fabric of 196 gsm. 21 tows from the fill direction were analyzed for darkness and the mean value of peak grayscale is reported in Table 2.

TABLE 1

| | | | | Drying | DSC cure | Mean |
|---|---|---|---|---|---|---|
| | | Carboxylic | Epoxy:amine | temp., | onset/peak | Grayscale |
| Sizing | Amine cure | acid | stoichiometry | C ° | temp., C ° | Peak value |
| Control 1 | — | — | — | 125 | — | 140.7 |
| Control 2 | — | — | — | 125 | — | 133.3 |
| Example 1 | Aradur 340 | acetic | 1:0.45 | 110 | 85.2/121.9 | 98.1 |
| Example 2 | Aradur 340 | fumaric | 1:0.45 | 150 | 114.2/135.2 | 82.7 |
| Example 3 | Aradur 340 | fumaric | 1:0.28 | 150 | 114.2/135.2 | 96.1 |
| Example 4 | Aradur 340 | lactic | 1:0.36 | 125 | 85.8/123.6 | 104.9 |
| Example 5 | Aradur 340 | acetic | 1:0.36 | 105 | 85.2/121.9 | 94.3 |
| Example 6 | Aradur 340 | iminodiacetic | 1:0.45 | 110/155 | 129.5/150.1 | 113.6 |
| Example 7 | Dodecyl | iminodiacetic | 1:0.36 | 110/155 | 130.3/136.8 | 131.9 |
| | amine | | | | | |
| Example 8 | Octadecyl | acetic | 1:0.36 | 135 | 83.9/100.0 | 107.2 |
| | amine | | | | | |
| Example 9 | Dodecyl | acetic | 1:0.36 | 135 | 83.9/100.0 | 120.9 |
| | amine | | | | | |
| Example 10 | Aradur 435 | fumaric | 1:0.36 | 160 | 77.8/130 | 105.7 |
| Example 11 | Aradur 435 | fumaric | 1:0.18 | 160 | 77.8/130 | 109.4 |
| Example 12 | Aradur 340 | fumaric acid | 1:0.36 | 160 | 83.2/117.0 | 107.2 |
| | | monoethyl | | | | |
| | | ester | | | | |
| Example 13 | BADG | decanoic | 1:0.36 | 125 | 73.2/125.1 | 116.0 |
| Example 14 | Aradur | iminodiacetic | 1:0.36 | 170 | 135.8/161.1 | 91.5 |
| | 3986 | | | | | |
| Example 15 | Aradur | oxamic | 1:0.36 | 180 | 156/171.9 | 106.7 |
| | 3986 | | | | | |
| Example 16 | Octadecyl | Glycolic acid | 1:0.36 | 125 | 74/125.3 | 118.7 |
| | amine | ethoxylate 4- | | | | |
| | | nonylphenyl | | | | |
| | | ether | | | | |
| Example 17 | Aradur | oxamic | 1:0.52 | 125/175 | 156/171.9 | 100.2 |
| | 3986 | | | | | |
| Example 20 | Aradur | acetic | 1:1.5 | 125 | 83.4/117.1 | 112.8 |
| | 3986 | | | | | |
| Example 21 | Aradur | acetic | 1:1.5 | 160 | 83.4/117.1 | 102.4 |
| | 3986 | | | | | |
| Example 22 | Aradur | acetic | 1:2 | 125 | 83.4/117.1 | 110.0 |
| | 3986 | | | | | |
| Example 23 | Aradur | acetic | 1:2 | 160 | 83.4/117.1 | 104.6 |
| | 3986 | | | | | |
| Comparative | Aradur 340 | — | 1:0.36 | 125 | 64.1/101.6 | 100.6 |
| Example 1 | | | | | | |
| Comparative | Jeffamine | — | 1:0.36 | 125 | 59.4/116.4 | 133.8 |
| Example 2 | M600 | | | | | |
| Comparative | Toximul | — | 1:0.36 | 160 | 109.2/150.1 | 130.3 |
| Example 3 | TA-8 | | | | | |
| Comparative | Aradur 435 | — | 1:0.36 | 125 | 66.0/110.0 | 105.6 |
| Example 4 | | | | | | |
| Comparative | Aradur | — | 1:0.36 | 125 | 49.8/92.0 | 108.6 |
| Example 5 | 3986 | | | | | |

TABLE 2

| | | | | Drying | Mean Grayscale |
|---|---|---|---|---|---|
| | Amine | Carboxylic | Epoxy:amine | temp., | Peak value, fabric, |
| Sizing | cure | acid | stoichiometry | C. ° | fill direction |
| Comparative | — | — | — | 125 | 136.7 |
| Example 6 | | | | | |
| Example 18 | Aradur 340 | fumaric | 1:0.28 | 150 | 109.9 |
| Example 19 | Aradur 340 | fumaric | 1:0.36 | 150 | 104.4 |

A further experiment was performed where fiber darkness variation was evaluated at different angles of observation (phi angle) for Control and certain darker Experimental fibers. As noted above, for each fiber, nine different areas were selected; within each of the nine areas, the grayscale value was recorded at numerous points. A median grayscale value for each of the nine areas was determined. For each fiber, at each angle of observation, a mean value of the nine median grayscale values was calculated. The data is shown in Table 3, and the results are shown in FIG. 1. It was found that the darker Experimental fibers all had lower variations in darkness than the control.

TABLE 3

| | Median | Median | Median |
|---|---|---|---|
| | Grayscale | Grayscale | Grayscale |
| | Darkness | Darkness | Darkness |
| | Mean, | Mean, | Mean, |
| Fiber | Max | Min | Max − Min |
| Control 1 | 147.2 | 60 | 87.2 |
| Example 15 | 124.5 | 43.1 | 81.4 |
| Example 14 | 119.6 | 41.4 | 78.2 |
| Example 10 | 108.5 | 38 | 70.5 |
| Example 12 | 96.2 | 38.4 | 57.9 |

Many modifications and other embodiments of the inventions set forth herein will come to mind to one skilled in the art to which the inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims.

Although specific terms are employed herein, they are used in a generic and descriptive sense only and not for purposes of limitation. Each embodiment disclosed herein is contemplated as being applicable to each of the other disclosed embodiments. All combinations and sub-combinations of the various elements described herein are within the scope of the embodiments.

1. A sizing composition comprising:
a. an epoxy-containing resin; and
b. a carboxylate salt of an amine, wherein the amine has the formula
RₙXₘQ
wherein:
Q is an amine-containing group, comprising at least one primary or secondary amine;
X is a polyether group selected from the group consisting of poly(propylene oxide) (PPO) compounds and poly(ethylene oxide) (PEO) compounds or a mix thereof;
m is an integer, where m≥0;
R is an aryl or alkyl group, wherein each alkyl group may be independently linear or branched, and wherein each alkyl group may independently be saturated or unsaturated; R contains from 0-10 heteroatoms; and R is either unsubstituted or substituted with 1-5 substituents selected from the group consisting of C₁-C₁₂ alkyl groups, C₁-C₁₂ heteroalkyl groups, C₆-C₁₄ aryl groups, and C₆-C₁₄ heteroaryl groups; and
n is an integer, with n≥0.

2. The composition of claim 1, wherein Q is a monoamine.

3. The composition of claim 1, wherein Q comprises a plurality of amino groups.

4. (canceled)

5. The composition of claim 1, wherein Q comprises a polyamidoamine.

6. The composition of claim 1, wherein Q comprises a epoxy-amine adduct.

7. (canceled)

8. (canceled)

9. The composition of claim 1, wherein m≥1.

10. The composition of claim 1, wherein X is absent.

11.-14. (canceled)

15. The composition of claim 1, wherein R is unsubstituted.

16. The composition of claim 1, wherein R is substituted.

17. The composition of claim 1, wherein n≥2.

18. The composition of claim 1, wherein the carboxylic salt is derived from a monocarboxylic acid.

19. The composition of claim 1, wherein the carboxylic salt is derived from a polycarboxylic acid.

20. (canceled)

21. The composition of claim 1, wherein the epoxy:amine molar ratio is from about 10:1 to about 1:10.

22. A carbon fiber prepared by having a composition according to claim 1 dried and cured on a surface thereof.

23. A carbon fiber-reinforced composite comprising the carbon fiber of claim 22.

24. The carbon fiber-reinforced composite of claim 23, comprising a resin matrix infused into the fiber.

25. A method of preparing a treated carbon fiber, said method comprising the steps of:
i) applying a composition as described in claim 1 to a carbon fiber, thereby forming a coated carbon fiber;
ii) drying the coated carbon fiber, and
iii) curing the coated carbon fiber;
so as to form a treated carbon fiber.

26. (canceled)

27. The method of claim 25, wherein step ii) is performed at a temperature between about 100° C. and about 190° C.

28. (canceled)

29. The method of claim 25, wherein step iii) is performed at a temperature between about 100° C. and about 190° C.

30. (canceled)

31. The method of claim 25, wherein step ii) and step iii) are performed concurrently.

32. The method of claim 25, wherein step ii) and step iii) are performed consecutively.
